(19) United States
(12) Patent Application Publication
(10) Pub. No.: US 2011/0277768 A1
(43) Pub. Date: Nov. 17, 2011

(54) Emergency Breathing Apparatus

(76) Inventors: Michael T. Hill, Swansea, IL (US); B. Kelley Posey, Edwardsville, IL (US)

(21) Appl. No.: 12/895,558

(22) Filed: Sep. 30, 2010

Related U.S. Application Data
(60) Provisional application No. 61/247,039, filed on Sep. 30, 2009.

(51) Int. Cl. A62B 7/10

(52) U.S. Cl. 128/205.28

(57) ABSTRACT

Breathing apparatuses which utilize active scrubbing in a closed loop system providing for scrubbing of air on exhalation, but inhalation to be from a clean air source without the air from that source passing back through an active filter immediately prior to inhalation. The systems and methods may also use endothermic reactions from repressurization of make-up air to cool the clean air source providing further comfort.

### CROSS REFERENCE TO RELATED APPLICATION(S)

This Application claims the benefit of U.S. Provisional Patent Application Ser. No. 61/247,039, filed Sep. 30, 2009, the entire disclosure of which is herein incorporated by reference.

### BACKGROUND OF THE INVENTION

1. Field of the Invention

This disclosure is related to the field of emergency breathing apparatuses for use in an environment where there are fires, smoke, contamination, industrial accidents, toxic substances, poisonous gas, or pollution.

2. Description of Related Art

The primary purpose of a breathing apparatus is to provide a method of transferring breathable gas from an artificial source to the lungs of its user. In many situations, an emergency may arise where an individual needs protection and a flow of oxygen in order to escape the oxygen-deprived environment. Concerns over the threat of terrorist use of chemical, biological, nuclear, or radiological weapons has prompted an increased interest in the effectiveness of an emergency breathing apparatus that can be used to allow emergency personnel to operate in a contaminated area, or to allow for protection of occupants during the evacuation of a building or mass transit vehicle. While concerns over these new threats have arisen, concerns about existing threats such as smoke, particulates, and even the very simple lack of air in confined spaces have not decreased.

Because of these problems, there is an increased interest in providing those who may be exposed to such threats with an emergency breathing apparatus that can allow for escape from their surroundings when the environment and atmosphere around them suddenly turns dangerous.

Generally, these apparatuses are intended for one time use, designed to be stored for a long period of time before use, intended to be relatively straightforward to use, and designed to provide for a relatively limited air supply (e.g. for 10 or 15 minutes) to allow the user time to escape from an environment, as opposed to operate within it. Basically, the apparatus serve to buy time for the individual during which they can move and operate without fear of being deprived of air.

While some types of emergency breathing apparatus already exist that are suitable for such uses, they often fall short of meeting desired characteristics. In general, emergency breathing apparatuses operate as a closed circuit. This circuit generally involves two main processes as the user breathes in and out of the apparatus: the release of oxygen into the apparatus (the oxygen source) and the removal of carbon dioxide (CO₂) (known as “scrubbing”) from the exhaled gas. These processes are generally combined in the apparatus and the user can then breath and inhale the resultant gas mixture. Generally, past known apparatuses have employed chemical oxygen generators as the oxygen source.

In regards to the scrubbing, active techniques are known to be generally more effective in removing CO₂ than passive technologies and therefore can provide for longer use in sealed (closed-circuit) breathing systems, but active scrubbers typically require the user to breathe through a canister containing the adsorbent chemical. This requires a human interface such as a mouth bit with a nose clip or a mouth/nose cup which forces the user to breathe in and out through the adsorbent canister. Breathing through the adsorbent canister increases the “work of breathing”. This increases the workload, decreases comfort level, and raises the air temperature as the person must work harder to breathe.

Additionally, in many of the known apparatuses, the exhaled CO₂ has traditionally been removed by processing with granular lithium hydroxide (LiOH), which absorbs the CO₂. This technique, however, often resulted in the granular LiOH abrading from the vibration of the chemical oxygen generator and other disturbances. The abrading of the LiOH dispersed dust in the apparatus, which was very caustic to a user's eyes, nose, and throat.

In addition to the difficulty in breathing and other problems that can be caused by past uses and operation of the canister, the action of the scrubbers in a canister removing CO₂ is often exothermic and can produce significant heat. As the use of a mouth bit or similar apparatus has previously required the user to breathe both in and out through the canister, on an exhalation, this will force hot air out of the canister which can be a problem if the exhalation is into a closed loop system (such as a breathing hood). Further, the air breathed in is also breathed through the canister and therefore is heated by the scrubbing action just prior to being inhaled. Additionally, chemical oxygen generators generally release oxygen at increased temperatures. While National Institute for Occupational Safety and Health (NIOSH) regulations allow for inhaled air to still be considered safe at 120° Fahrenheit, breathing in air at this temperature is very uncomfortable and can result in undesirable disruption, ceased use of the breathing apparatus, or further fatigue. These are undesirable situations when a person is trying to evacuate from an emergency situation.

Taking these variables together, what is needed in the art of emergency breathing apparatuses is a safer and more efficient apparatus and process to be used in emergencies where an individual needs protection and a flow of oxygen in order to quickly escape the oxygen-deprived environment.

### SUMMARY OF THE INVENTION

Because of these and other problems in the art, described herein are breathing apparatuses which utilize active scrubbing in a closed loop system providing for scrubbing of air on exhalation, but inhalation to be from a clean air source without the air from that source passing back through an active filter immediately prior to inhalation. The systems and methods may also use endothermic reactions from repressurization of make-up air to cool the clean air source providing further comfort.

The emergency breathing apparatus described herein is comprised of: a breathing bag; an oxygen source for supplying oxygen to the breathing bag; and a scrubber assembly connected to the breathing bag and comprising: a scrubber filter for removing carbon dioxide; a mouthpiece; and a valve assembly, the valve assembly: accepting exhaled breath from the mouthpiece and passing the exhaled air into and through the scrubber filter whereby the exhaled breath enters the breathing bag with at least some of the carbon dioxide removed therefrom; and restricting the inhaled air from the mouthpiece from passing through the scrubber filter whereby the inhaled air is drawn from the breathing bag without first passing through the filter.

In one embodiment of the emergency breathing apparatus, the breathing bag is a hood. In another embodiment, the hood comprises sealing membrane for sealing a user's head from the external atmosphere and defining an interior volume of the hood for accommodating the user's head. In yet another embodiment, the scrubber assembly is within the interior volume of the hood.

In some embodiments of the emergency breathing apparatus, the breathing bag is an external breathing bag.

In another embodiment of the emergency breathing apparatus, the oxygen source is comprised of a pressurized oxygen source. In another embodiment, the pressurized oxygen source is pure oxygen.

In some of the embodiments of the emergency breathing apparatus, the breathing bag is comprised of a fluoropolymer. In another embodiment, the fluoropolymer is polytetrafluoroethylene.

In one embodiment of the emergency breathing apparatus, the scrubber filter is comprised of a carbon dioxide absorbent chemical. The carbon dioxide absorbent chemical is comprised of lithium hydroxide in other embodiments of the emergency breathing apparatus.

In yet other embodiments, the emergency breathing apparatus further comprises a noseclip for restricting inhaled and exhaled breath of a user from flowing into and out of a user's nose. In some of these embodiments, the mouthpiece accepts the inhaled and exhaled breath.

In some embodiments of the emergency breathing apparatus, the valve assembly comprises at least one one-way valve. In other embodiments, the valve assembly comprises two one-way valves.

In yet other embodiments, the breathing bag inflates during use. The breathing bag further comprises an emergency release valve for deflating the breathing bag in some other embodiments.

In one embodiment of the emergency breathing apparatus, the mouthpiece comprises a portion of a facemask.

The emergency breathing apparatus is stored in a barrier pouch in some other embodiments.

In one embodiment, the emergency breathing apparatus is comprised of: a breathing bag; a means for supplying oxygen to the breathing bag; and a scrubber assembly connected to the breathing bag and comprising: a means for removing carbon dioxide; and a means for: accepting exhaled breath and passing the exhaled air into and through the means for removing carbon dioxide whereby the exhaled breath enters the breathing bag with at least some of the carbon dioxide removed therefrom; and restricting the inhaled air from passing through the means for removing carbon dioxide whereby the inhaled air is drawn from the breathing bag without passing through the means for removing carbon dioxide.

### BRIEF DESCRIPTION OF THE DRAWINGS

FIG. 1 provides a perspective conceptual view of an embodiment of a hooded emergency breathing apparatus.

FIG. 2 provides a rear view of the embodiment of FIG. 1.

FIG. 3 provides a side view of the embodiment of FIG. 1.

FIG. 4 provides a perspective conceptual view of an embodiment of an emergency breathing apparatus utilizing an external breathing bag.

### DESCRIPTION OF THE PREFERRED EMBODIMENT(S)

The present disclosure describes an emergency breathing apparatus (100) or (600) with a relatively limited supply of air in order to quickly escape an oxygen-deprived environment. Generally, the apparatus (100) or (600) disclosed herein consists of a number of component parts. In this disclosure, the component parts of the emergency breathing apparatus (100) or (600) will first be discussed separately. Then the component parts will be discussed together as a functioning emergency breathing apparatus (100) or (600).

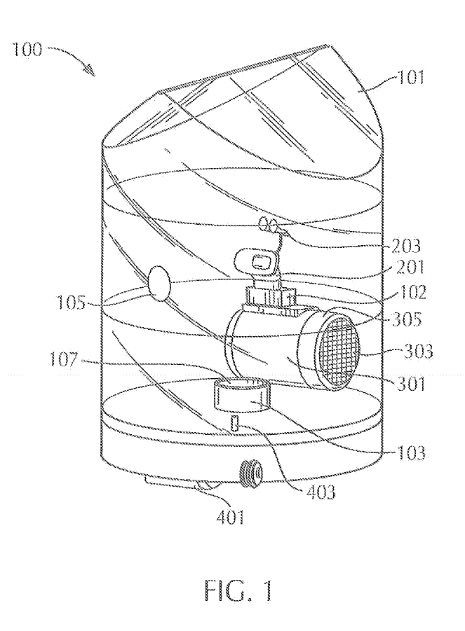

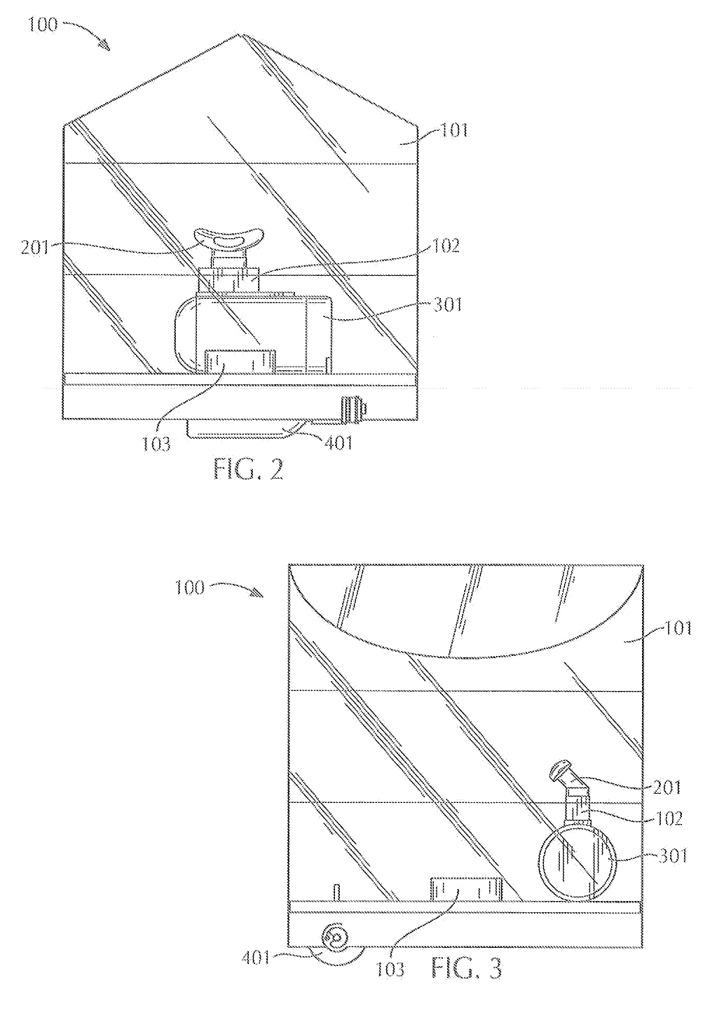

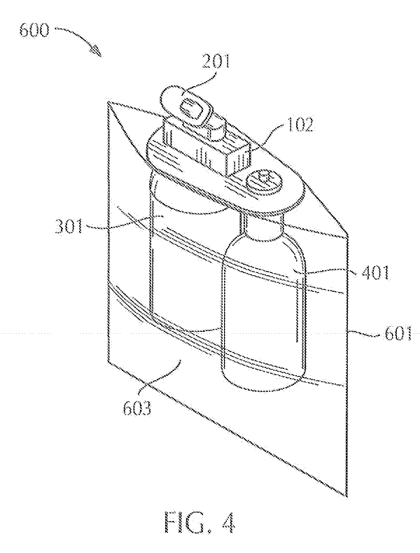

FIGS. 1 through 3 provide for a first embodiment of an emergency breathing apparatus (100) which, in this embodiment, utilizes the volume inside a breathing bag which operates as an evacuation hood (101) as an inhalation air source. The apparatus (100) is designed to provide personal protection for all functions of the user's head from dangerous environments caused by environmental hazards such as, but not limited to: poisonous gas, smoke, fire, chemical, biological, radiological, and nuclear hazards.

In an embodiment, the apparatus (100) generally comprises a heat resistant hood (101) which operates as the breathing bag and encloses the head of a user with an attached sealing membrane (103) that seals around the user's neck. The sealing membrane (103) is preferably elastic; however, one of ordinary skill in the art would readily recognize that any seal could be used, including, for example, an adjustable clip, a string, or a pull cord. The hood (101) may be manufactured of any material and, depending on the hazardous environment expected, may be chemically, biologically, nuclear, or other resistant. Preferably, the hood (101) is made from a heat and chemical resistant fluoropolymer, such as polytetrafluoroethylene. The entire hood (101) is also preferably transparent, allowing for a full, unobstructed field of view through the shell. None of these characteristics (e.g., heat resistance or full transparency), however, is necessary. In an alternative embodiment, for example, the hood (101) may be comprised primarily of an opaque material with only a small transparent portion for viewing outward through the hood (101).

The hood (101) is also generally designed to resist intrusion by materials in the environment, particularly contaminants, heat, smoke, fire, chemical, nuclear, or other similar hazards. Additionally, the hood (101) includes a sealing membrane (103) to seal securely around the neck, ensuring that the interior of the hood is sealed from the external atmosphere, which may not contain breathable air, such as smoke, or may be at an elevated temperature. This seal around the user's neck also advantageously allows for the breathing of the internal, breathable air in the volume of the hood (101).

There is also scrubber assembly (301) attached inside the hood (101). The scrubber assembly (301) further includes an active scrubbing filter (303), discussed more fully below. There is then attached a mouthpiece (201) and nose clip (203), or any other similar structure for encouraging the user to breath into the scrubber assembly (301), which are all inside the hood (101). In other words, the nose clip (203) restricts the user from inhaling and exhaling directly into the hood (101), encouraging the user to breath into the scrubber assembly (301) through the mouthpiece (201). This precise configuration is by no means necessary. Instead, the important aspect is to insure that the user breathes out into the scrubber assembly (301). One of ordinary skill in the art would readily recognize that other configurations or breathing means would also suffice to carry out this breathing and may include a single means for breathing and scrubbing. For example, in a separate embodiment, the user could breath in and out through his/her nose and into the scrubber assembly (301). Alternatively, a configuration in which the user exhales into the scrubber assembly (301), while inhaling around a mouthpiece (201) and from the hood (101) would also suffice. Additionally, the mouthpiece (201) may not go directly into the mouth of a user, and instead, the mouthpiece (201) may merely be part of a facemask which covers the user's mouth or nose or both.

In an embodiment, the apparatus (100) also includes an attached oxygen source such as a pressurized oxygen cylinder (401) feeding into the hood (101) via a regulator (403). The oxygen cylinder (401) may be of any size but will generally be designed to provide from between 10 and 30 minutes of oxygen to the average person using the apparatus (100), and more preferably will be designed to provide from between 10 and 15 minutes of oxygen to the average person. In an embodiment, this is preferably a 39-, 44- or 60-liter compressed tank of pure oxygen which is then mixed with closed-circuit air inside the hood (101) to provide breathable air that is not pure oxygen.

As discussed more fully below, pressurized oxygen is the preferred source and provision means of oxygen; however, the pressurized oxygen cylinder is by no means the only available source, as one of ordinary skill in the art would readily recognize. Alternatively, the oxygen source or oxygen provision means may be another source of breathable oxygen such as, but not limited to, a tank performing a contained reaction which produces oxygen, a portable oxygen concentrator, liquid oxygen, or any other similar source or provision means of pure or concentrated oxygen. In a still further embodiment, the source or provision means need not include pure oxygen, but may include pressurized air, inert gases and oxygen, or another mixture of gases which includes oxygen and would generally be safe for human respiration.

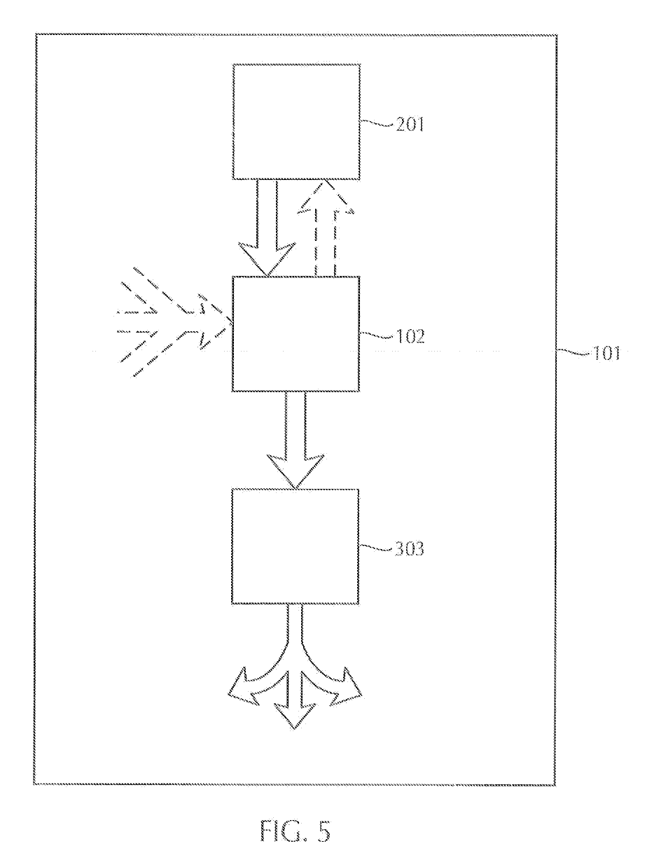

The scrubber assembly (301) will generally include a structure to provide for valved breathing. Specifically, in this embodiment, the scrubber assembly will comprise a valve assembly (102) which allows for the user to exhale and have the exhaled breath pass through the mouthpiece (201) and the filter (303), while air which is inhaled from the assembly (301), i.e., the inhaled breath, does not pass through the filter (303) but instead, in this embodiment, is obtained from the ambient air inside the hood (101). A flowchart of an embodiment of this valved breathing is depicted in FIG. 5, with the solid arrows depicting the exhaled breath and the dashed arrows depicting the inhaled breath. While the flowchart in FIG. 5 depicts valved breathing contained with the hood (101), this is merely an exemplary depiction of a possible flow of the valve breathing. For example, in an alternative embodiment, the mouthpiece (201) may be located outside the breathing bag (603), with the remaining steps of the flowchart occurring inside the breathing bag (603), as suggested in the alternative embodiment depicted in FIG. 4. Additionally, the precise configuration of the valve assembly can vary. For example, the valve assembly may comprise a single one-way valve. Alternatively, the valve assembly may comprise two one-way valves.

The filter (303) will generally contain a carbon dioxide (CO₂) adsorbent chemical (scrubber) such as, but not limited to, lithium hydroxide (LiOH). Although lithium hydroxide is disclosed as a preferred scrubber, it is by no means the only scrubber. As one of ordinary skill in the art would readily recognize, any known scrubber could be used, including, but not limited to: soda lime, barium orthotitanate, lithium orthosilicate, Litholyme™, Decarbite® Granules, Wakolime™, Dragersorb™, Medisorb™, or Amsorb™

The chemical process for removing carbon dioxide by reacting with lithium hydroxide is generally exothermic and is well understood by those of ordinary skill. However, the exothermic nature of the reaction means that air passing through the filter (303) is generally heated considerably by the scrubbing action. In an embodiment of the apparatus (100), the air is advantageously saved from being provided with significant extraneous heat.

The reduction on total heat is three-fold. In the first instance, inhaled air does not pass through the filter (303) immediately prior to being inhaled. Because the user does not breathe in air exposed to the exothermic scrubbing action/reaction, the resultant inhaled air is at a lower temperature than other known apparatuses. Secondly, since the air is in a closed system, the air is only exposed to the exothermic reaction half as often as it would be if both inhalation and exhalation were through the filter. This generally results in less heat being generated in total, keeping the air at a lower temperature. Thirdly, in a preferred embodiment of the apparatus (100), oxygen is supplied to the hood via a compressed oxygen source. This oxygen is supplied at a temperature significantly below previously used oxygen sources (e.g., a chemical oxygen generator), and this supplied oxygen is then combined with the hotter exhaled and scrubbed air and with the remaining ambient air already in the hood (101). This advantageously serves to reduce the temperature of the air inside the hood (101) that the user will then inhale. As a result of all these reductions on total heat, the breathing environment is generally more comfortable, there is less likelihood of a disruption of the breathing system, and there is a decrease in fatigue for the user.

The apparatus (100) will generally be stored in a vacuum sealed barrier pouch or other storage container to be opened and donned quickly in an emergency. To use the apparatus (100), a user will generally remove the apparatus (100) from storage by tearing open a pouch or otherwise opening the container and removing the apparatus (100). Any known container available for storage and easy access may be used without departing from the spirit and scope of the invention.

In order to use the apparatus (100) the user will place the hood (101) over his/her head by inserting his/her head through an opening (107) in the sealing membrane (103). This places the user's entire head inside the internal volume of the hood (101). To get their head into the hood (101), the user will generally place both hands inside the membrane (103) opening (107), with palms facing each other or facing outwards, stretch the membrane (103) open by spreading the hands apart, and lift up the opened hood (101) with both hands. The user would then lower the membrane (103) down over the head to place the head inside the hood (101). The hands are removed allowing the membrane (103) to seal securely around the neck, ensuring that the interior of the hood (101) is sealed from the external atmosphere, which may not contain breathable air.

The user will then seal their mouth around the mouthpiece (201) and use the nose clip (203) to seal their nose (which may be done by manipulating these objects through the outside of the hood (101) material or while the user's hands are inside the membrane (103)). This generally only allows the user to breathe through their mouth and thus ensures that all of their breaths (both in and out) will pass through the assembly (301). Once donned, the user may actuate an oxygen flow valve to begin the flow of oxygen to the hood (101). This actuation of the oxygen after donning the hood (101) is by no means the only way of initiating the oxygen flow. Alternatively, oxygen flow may be initiated prior to the user donning the hood, or oxygen flow may begin automatically without the user initiating, such as a system that detects that the apparatus (100) is being removed from its container, is being donned, or is at another point when oxygen flow commencement is desired.

The user can breathe inside the hood (101) by breathing in and out through the mouthpiece (203). In this regard, the hood (101) operates advantageously as both a breathing bag and shell to protect the user's face from the exterior environment, whether it be smoke, fire, chemical, nuclear, or other similar hazards.

With an exhalation, the breath will open the valve assembly (102), allowing the breath to pass through the valve assembly (102) in the scrubber assembly (301) and into the scrubber filter (303) which will serve to remove at least some of the CO₂ from the exhaled breath. The remaining substance of the breath will then pass out of the scrubber filter (303) via an exhalation port (305) and into the hood (101). The air of this exhalation will generally have been heated by the action of the scrubber filter (303) removing CO₂ therefrom and therefore can have a very high temperature (upwards of 130° Fahrenheit). Once in the interior volume of the hood (101), the exhaled air will begin to mix with air already inside the hood (101) and with oxygen which is being supplied to the hood (101) by the oxygen source (401). Thus, the heat will be distributed within the hood (101), resulting in an air temperature inside the hood generally below that of the hot immediately exhaled air.

In the event that the oxygen source (401) is a compressed tank, as is preferred, the make-up oxygen being supplied to the hood (101) will generally be cold due to the gas in the tank (401) returning to ambient pressure. The cooling effect occurs as predicted by the generalized ideal gas law, notably as pressure decreases the temperature decreases. Therefore, because the oxygen depressurizes as it leaves the pressurized cylinder (401), the oxygen being ejected will be cool. Thus, this cold make-up oxygen will combine with the hot exhaled and scrubbed air and with the remaining ambient air already in the hood (101). This advantageously serves to reduce the temperature of the air inside the hood (101) that the user will then inhale. In past known apparatuses, the oxygen source supplied the oxygen at temperatures significantly greater than the compressed tank oxygen temperature, creating a higher resultant temperature inside the hood (101). Although preferred, this compressed tank as the oxygen source is by no means necessary, as one of ordinary skill in the art would readily appreciate. As discussed above, any suitable source of oxygen would suffice.

Once the user has completed their exhalation, the user will begin to inhale. The change in pressure from the user's exhalation to the user's inhalation will generally cause the valve assembly (102) in the scrubber assembly (301) to change position and seal off the scrubber filter (303) from the air path. Instead, inhaled air will be drawn in from the volume of the hood (101) through a different air path. This inhaled air, as discussed above, includes the combination of scrubbed air, ambient air, and make-up oxygen. Once the inhalation is complete, the above process will repeat.

The use of the hood (101) with make-up air provides for a number of benefits. In the first instance, air being inhaled is cooler because it is not passing through the scrubber filter (303) immediately prior to inhalation. Thus, the inhaled air is advantageously not being subjected to the exothermic, heat increasing reaction inside the filter (303) as it is inhaled. Further, the make-up oxygen and distribution of the hot air into the ambient air in the hood (101) serves to cool the exhaled air by heat transfer. This generally results in the air in the hood heating slower than would be the case if the inhalation air was only that air immediately exhaled or if the oxygen was supplied at a higher temperature, as is the case, for example, with chemical oxygen generators. Further, since the air in the hood also only passes through the scrubber filter (303) in one direction, the air is generally not heated as much by the filtration process, resulting in the inhaled air (and air in the hood generally) remaining still cooler.

Because make-up oxygen is continually being added to the hood, the hood will generally start to inflate as the user breathes due to an increase in total gas volume in the hood. This provides for positive pressure inside the hood (101) which helps inhibit the entrance of contaminants from the outside environment into the closed loop breathing system through the neck seal or any other potentially imperfect seal in the components. When the canister (401) of oxygen is depleted, the hood (101) will start to deflate indicating that the hood (101) needs to be removed relatively quickly. By this time, the user should be in a safe area and may remove and discard the apparatus (100) which is generally only intended for a single use. Because of the pressurized nature of the hood (101), in order to prevent the over-pressurization of the hood (101) and a possible rupture, or simply discomfort to the user's head which is contained inside the pressurized environment of the hood (101), the hood (101) may include an emergency release valve (105), as shown in the depicted embodiment, to allow for the hood (101) to de-pressurize or deflate to a safe level should it get above such level.

Turning now to FIG. 4, an alternative embodiment of a closed circuit breathing system (600) is shown which also only utilizes the filter on exhalation. In the embodiment of FIGS. 1-3, make up oxygen was supplied to the hood (101) which was worn over the head and from which the inhalation occurred. In most instances, the inclusion of a hood (101) will be preferred as it not only protects the user's breathing, but also inhibits the contaminants from contacting eyes, ears, or other structures of the head which may also be effected by or susceptible to the same contaminants. The user is, therefore, in the apparatus (100) of FIGS. 1-3, effectively provided with a self-contained safe environment surrounding their head, which advantageously operates as a breathing bag.

In some situations, however, the person who would be using the apparatus would be unable to utilize a hood (101). For example, the user may be wearing a helmet with a light source thereon (for example, if they were wearing miner's hard hat) that is needed both for safety and for illumination, even in the emergency escape situation. In these situations, it may not be possible for the user to don the apparatus (100) entirely over their head as the helmet may be in the way. Thus, such an individual may be unable to safely don a apparatus (100) using a hood (101).

In such a situation where the hood (101) would not be desired, the alternative embodiment of FIG. 4 may be used. In this embodiment, the apparatus (600) replaces the hood (101) with an external breathing bag (601). The external breathing bag (601) serves the same general purpose as the hood (101) in acting as the source of incoming air and to close the user's breathing loop; however, it is not designed to cover the head of the individual but instead is separate and acts as a surround for the assembly (301), the source of make-up air and, in the depicted embodiment, also encloses the oxygen source (401).

The breathing pattern of the person using the embodiment of FIG. 4 is generally the same as in the embodiment of FIGS. 1-3. Specifically, the user will place the mouthpiece (201) in their mouth and may utilize a nose clip (203) to seal their nose. The user will then breathe normally through the mouthpiece (201). Exhaled air will pass into the assembly (301) and through the filter (303) which will serve to scrub the exhaled air. The exhaled air will then pass into the external breathing bag (601) where it will be allowed to mix with the oxygen from the tank (401) and the ambient air in the internal volume (603) of the bag (601).

When the user inhales, a valve assembly (102) or similar structure in the scrubber assembly (301) will alter position so that the inhaled air is obtained from the volume (603) of the external breathing bag (601) which has been cooled by the addition of the fill oxygen (and may also be further cooled by the presence of the oxygen tank (401) inside the bag). Again, any oxygen source may be utilized, but a compressed oxygen source advantageously cools the air to be inhaled to a greater degree than many other oxygen sources, and is thus the preferred source. This air is directed through the assembly (301) and into the mouthpiece (201) where the user will then inhale it. The process of exhalation/inhalation will then repeat with each breath.

Like the hood (101), the external breathing bag (601) will generally inflate over time due to the addition of the fill oxygen. Once the oxygen supply (401) is depleted, the bag (601) will deflate to indicate that the tank (401) is empty and air is running low. Also, as in the embodiment of FIGS. 1-3, the bag (601) may include a pressure release valve (not shown) to prevent over-pressurization and possible rupture of the bag (601).

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. An emergency breathing apparatus, said emergency breathing apparatus comprising:
a breathing bag;
an oxygen source for supplying oxygen to the breathing bag; and
a scrubber assembly connected to the breathing bag and comprising:
a scrubber filter for removing carbon dioxide;
a mouthpiece; and
a valve assembly, the valve assembly:
accepting exhaled breath from the mouthpiece and passing the exhaled air into and through the scrubber filter whereby the exhaled breath enters the breathing bag with at least some of the carbon dioxide removed therefrom; and
restricting the inhaled air from the mouthpiece from passing through the scrubber filter whereby the inhaled air is drawn from the breathing bag without first passing through the filter.

2. The emergency breathing apparatus of claim 1, wherein the breathing bag is a hood.

3. The emergency breathing apparatus of claim 2, wherein the hood further comprises a sealing membrane for sealing a user's head from the external atmosphere and defining an interior volume of the hood for accommodating the user's head.

4. The emergency breathing apparatus of claim 3, wherein the scrubber assembly is within the interior volume of the hood.

5. The emergency breathing apparatus of claim 1, wherein the breathing bag is an external breathing bag.

6. The emergency breathing apparatus of claim 1, wherein the oxygen source is comprised of a pressurized oxygen source.

7. The emergency breathing apparatus of claim 6, wherein the pressurized oxygen source is pure oxygen.

8. The emergency breathing apparatus of claim 1, wherein the breathing bag is comprised of a fluoropolymer.

9. The emergency breathing apparatus of claim 8, wherein the fluoropolymer is polytetrafluoroethylene.

10. The emergency breathing apparatus of claim 1, wherein the scrubber filter is comprised of a carbon dioxide absorbent chemical.

11. The emergency breathing apparatus of claim 10, wherein the carbon dioxide absorbent chemical is comprised of lithium hydroxide.

12. The emergency breathing apparatus of claim 1, further comprising a noseclip for restricting inhaled and exhaled breath of a user from flowing into and out of a user's nose.

13. The emergency breathing apparatus of claim 12, wherein the mouthpiece accepts the inhaled and exhaled breath.

14. The emergency breathing apparatus of claim 1, wherein the valve assembly comprises at least one one-way valve.

15. The emergency breathing apparatus of claim 1, wherein the valve assembly comprises two one-way valves.

16. The emergency breathing apparatus of claim 1, wherein the breathing bag inflates during use.

17. The emergency breathing apparatus of claim 16, wherein the breathing bag further comprises an emergency release valve for deflating the breathing bag.

18. The emergency breathing apparatus of claim 1, wherein the mouthpiece comprises a portion of a facemask.

19. The emergency breathing apparatus of claim 1, wherein the emergency breathing apparatus is stored in a barrier pouch.

20. An emergency breathing apparatus, said emergency breathing apparatus comprising:
a breathing bag;
a means for supplying oxygen to the breathing bag; and
a scrubber assembly connected to the breathing bag and comprising:
a means for removing carbon dioxide; and
a means for:
accepting exhaled breath and passing the exhaled air into and through the means for removing carbon dioxide whereby the exhaled breath enters the breathing bag with at least some of the carbon dioxide removed therefrom; and
restricting the inhaled air from passing through the means for removing carbon dioxide whereby the inhaled air is drawn from the breathing bag without passing through the means for removing carbon dioxide.
